(19) United States
(12) Patent Application Publication
(10) Pub. No.: US 2002/0039476 A1
(43) Pub. Date: Apr. 4, 2002

(54) Cable retention and bend radius control apparatus

(76) Inventors: Troy W. Sauve, Kanata (CA); Raymond Woo, Ottawa (CA)

Correspondence Address: BLAKE, CASSELS & GRAYDON LLP, Commerce Court West, Box 25, 199 Bay Street, Toronto, ON, M5L 1A9, CA

(21) Appl. No.: 09/761,714

(22) Filed: Jan. 18, 2001

(30) Foreign Application Priority Data
Sep. 25, 2000 (CA) 2,320,650

(51) Int. Cl. G02B 6/00

(52) U.S. Cl. 385/134

(57) ABSTRACT

There is provided a clip for retaining and controlling the bend radius of signal carrying cable such as fiber optic cable. The clip may be used in association with electronic equipment, such as telecommunications switching equipment. The clip retains and guides at least one fiber optic cable connecting a communications network to electronic circuitry units which form part of the electronic equipment. In compliance with Bellcore standards, the clip provides means for bend radius control which ensures that the fiber optic cable does not have a bend radius of less than one inch as it is dressed between the electronic circuitry units and the communications network. By retaining one or more cables, the clip is intended to minimize that fiber optic cable catches on the equipment and clothing of service personnel. Furthermore, by keeping the cables associated with an electronic circuitry unit together, service personnel are less likely to make mistakes when reattaching cables.

### FIELD OF THE INVENTION

The present invention relates generally to the field of cable management apparatus and more particularly, to an apparatus for maintaining a predetermined bend radius in signal carrying cable. The apparatus may also be used for mounting signal carrying cable to an equipment enclosure containing equipment to which the signal carrying cable is connected.

### BACKGROUND OF THE INVENTION

Electronic equipment conventionally comprises an enclosure such as a box-shaped housing containing electronic circuitry. In some instances, the front of such housing is open so as to provide access to shelves, each of which may be configured with receiving stations for holding electronic circuitry units in a side-by-side relationship. Housings of this nature are prevalent in telecommunications equipment applications. When installed into such housings, one or more of these electronic circuitry units may be connected to a communications network using signal carrying cable, such as fiber optic cable. The fiber optic cable carries communication signals to and from the electronic equipment. Typically, the equipment is attached to a support structure therefor, such as a vertically disposed rack, as is well-known to those versed in this art. Several racks may be lined up side by side and organized into parallel rows known in this art as equipment line-ups. Each row is separated from the other by a predetermined distance which provides access to the electronic equipment so that the equipment may be maintained or serviced.

Current cable management systems are typically disposed horizontally across the open front of an equipment enclosure of the type previously described, in proximity to the electronic circuitry units which are serviced by the systems. These systems usually comprise a generally rectangular planar bridging member that is attached to the edges or sides of the equipment enclosure, with the planar surface of the member being parallel to the plane of the open front of the equipment enclosure. Typically, the planar bridging member is placed beneath the electronic circuitry units for which the member performs cable management. Protruding normal to the planar member, and away from the enclosure, are several, typically sixteen, posts with oval cross-sections. These posts are typically permanently attached to the planar member. Each post is oriented so that the major axis of the oval cross-section is rotated approximately 45 degrees from vertical. The free or distal end of each post is provided with a flange, extending in a plane parallel to that of the planar member. The flange typically extends from the entirety of the circumference of the oval cross-section. A second generally planar member depending from, and generally perpendicular to, the lower edge of the bridging member forms an upwardly facing horizontal trough, whose function is described more fully below.

When the cable management apparatus of the known type is installed, fiber optic cables are initially dressed into positions such that each cable hangs generally vertically from its respective connection port on the electronic circuitry units over a portion of the front surfaces of the units. Each cable is then wrapped around a portion of the longitudinal surface of the post most closely located to the respective circuitry unit to which the cable in question is connected. The flange on the end of the post serves, to some extent, to discourage the cable from sliding off the post. Once partially wrapped around the post as aforesaid, the cables are drawn into the horizontal trough. This trough supports and guides the cables horizontally across the front surface of the housing, towards one of the two vertical edges of the equipment enclosure. The cables are then directed along a vertical side of the equipment enclosure to either the ceiling or into a sub-floor cable raceway system.

Because the cables are only partially wrapped around the posts, they may readily slide off the posts and hang freely when disturbed, for example as may occur when the associated electronic circuitry units are serviced. When the cables no longer contact the posts and hang freely from the equipment enclosure, they may at times accidentally catch on the equipment or clothing of service personnel and become damaged, thereby resulting in a disruption in the signal carried by the cable. This may also lead to increased maintenance costs, as those skilled in this art will appreciate.

Since the post does not fixedly retain the cable, problems may also arise because the cable can slide along the surface of the post and traverse the curved surface at an angle, instead of remaining parallel to the planar member. This may cause the cable 22 to bend unduly, damaging the cable and causing a loss of the signal being carried by the cable. If the cable becomes damaged, it must be replaced. Users of the communication signal carried by the damaged cable also may lose revenue for the time that they are unable to use the fiber optic cable.

Another limitation of present cable management systems is that the ordering and organization of cables may not be adequately maintained during servicing of an electronic circuitry unit. During servicing, the signal carrying cables associated with a unit are typically temporarily disconnected from the unit. This causes the cables to hang freely, away from the cable management apparatus, and potentially to intermingle, making it difficult for service personnel to reconnect the cables correctly in their corresponding original locations.

Known cable management systems occupy the space which extends outwardly adjacent the electronic equipment enclosure. The posts of current cable management systems typically protrude approximately three inches beyond the front of the equipment enclosure. Given that the space between the parallel rows of the equipment line-ups is limited, this protrusion may interfere with the mobility of service personnel. The protrusion may also accidentally catch on the clothing and equipment of service personnel. Furthermore, the bridging member typically occupies vertical space in the equipment enclosure of 1.75 inches, or one vertical unit (“VU”) as this measure is termed in the art. This use of vertical space limits the space available for electronic units and other equipment within the equipment enclosure.

Based on the foregoing, it would be desirable to develop alternative means for retaining and routing signal carrying cable while attempting to alleviate or minimize excessive bending or other mechanical disruption of the cable.

### SUMMARY OF THE INVENTION

The invention consists of an apparatus for retaining and guiding a signal carrying cable; and for controlling the bend radius of a signal carrying cable. According to one broad aspect of the invention, the apparatus comprises a generally planar member and a member with a convex curved surface presenting a predetermined radius of curvature. The member with the curved surface is attached adjacent to the generally planar member with the curved surface oriented generally perpendicular to the plane of the generally planar member. The signal carrying cable may contact the curved surface to thereby cause redirection of the orientation of the signal carrying cable while maintaining the signal carrying cable at a bend radius which is no less than said predetermined radius of curvature. The invention further comprises a first cable retaining member which depends from the generally planar member. A second cable retaining member for retaining the signal carrying cable is also provided. The second cable retaining member may depend from either the curved surface or the first cable retaining member to thereby form a cable channel. The cable channel is generally defined by the generally planar member, by the curved surface, and by the first and second cable retaining members. At least one signal carrying cable is locatable into the cable channel. The first and second cable retaining members are oriented such that an opening is provided between said first and second cable retaining members, the curved surface and the generally planar member, through which said at least one signal carrying cable may be introduced and retained.

### BRIEF DESCRIPTION OF THE DRAWINGS

For a better understanding of the present invention and to show more clearly how it may be carried into effect, reference is now made, by way of example only and not of limitation, to the accompanying drawings in which:

FIG. 1 is an elevational view of a typical installation of a cable bend radius control apparatus according to a first illustrative embodiment of the invention, showing a face panel of telecommunications equipment to which the apparatus is attached;

FIG. 2 is a perspective view of the cable bend radius control apparatus according to the illustrative embodiment of FIG. 1;

FIG. 3 is another perspective view of the apparatus of FIG. 2, viewed from a direction opposite to that of FIG. 2;

FIG. 4 is a perspective view of the apparatus of FIG. 2 and a lever, wherein the apparatus is aligned to engage with the lever;

FIG. 5 is a perspective view of the apparatus of FIG. 2 and the lever of FIG. 4, wherein the apparatus is shown engaged with the lever;

FIG. 6 is a perspective view of FIG. 5, viewed from a direction opposite to that of FIG. 5;

FIG. 7 is a perspective view of a third illustrative embodiment of the cable bend radius control apparatus;

FIG. 8 is another perspective view of the third illustrative embodiment of the cable bend radius control apparatus shown in FIG. 7, viewed from a direction opposite to the view of FIG. 7;

FIG. 9 is a side view of the third illustrative embodiment of the cable bend radius control apparatus shown in FIG. 7;

FIG. 10 is a perspective view of the bend radius control apparatus shown in FIG. 7 installed in a trough therefor;

FIG. 11 is a front view of a typical installation of a cable bend radius control apparatus according to the third illustrative embodiment of the invention, showing a face panel of telecommunications equipment to which the apparatus is attached;

FIG. 12 is a perspective view of a second illustrative embodiment of the cable bend radius control apparatus and an actuating lever for securing and releasing an electronic circuitry unit of the telecommunications equipment shown in FIG. 11, wherein the apparatus is aligned to engage with the lever;

FIG. 13 is another perspective view of the apparatus and lever of FIG. 12, viewed from a direction opposite to the view of FIG. 12;

FIG. 14 is an elevational view of the apparatus and lever of FIG. 12; and

FIG. 15 is an exploded elevational side view of the apparatus and lever of FIG. 12, viewed in a direction transverse to that of FIG. 14.

### DETAILED DESCRIPTION OF ILLUSTRATIVE EMBODIMENTS OF THE INVENTION

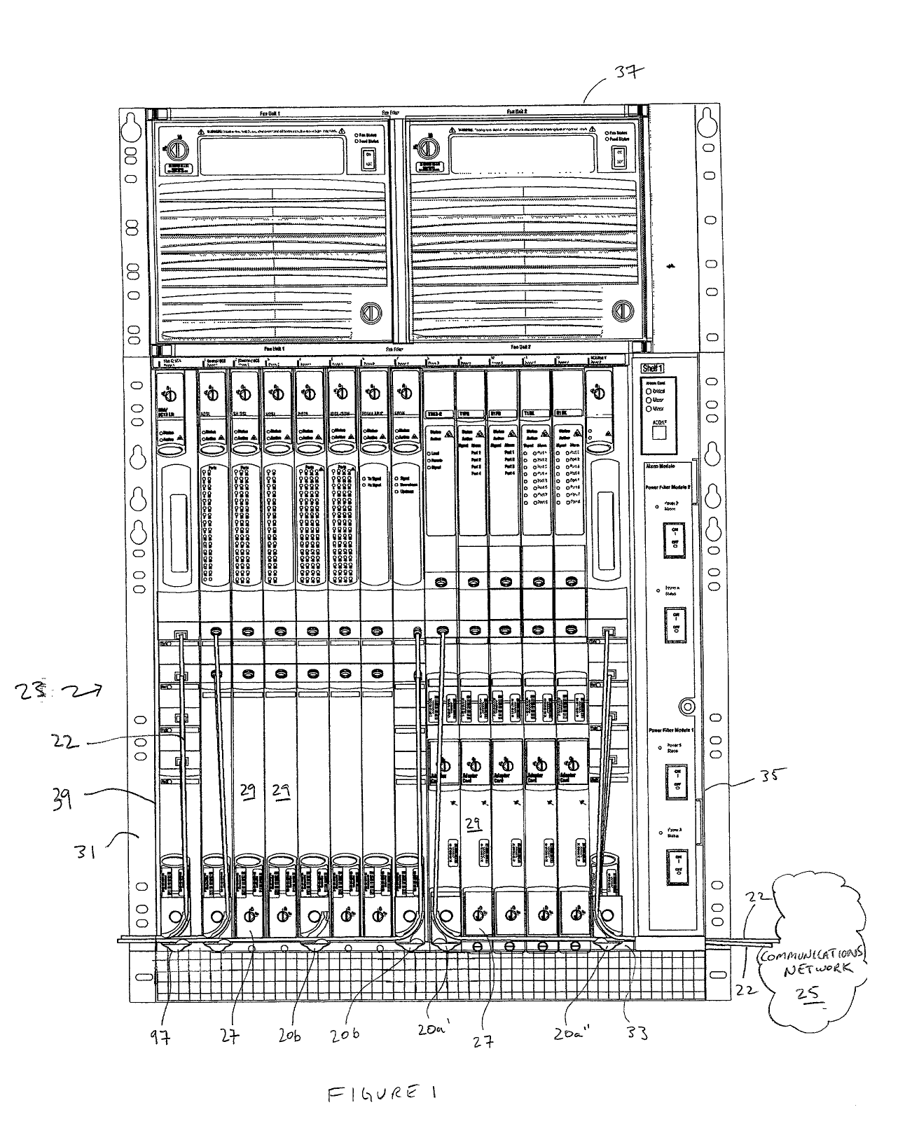

Referring to FIG. 1, a first illustrative embodiment of the claimed invention in the form of a cable bend radius control apparatus, for instance a clip 20a, is used to maintain at least one signal carrying cable 22 at a predetermined radius of curvature. The clip 20a also retains the cable 22, which is typically connected to electronic equipment 23. In an illustrative embodiment of the invention, the cable is fiber optic cable 22 which connects a communications network 25 to plug-in electronic circuitry units 29 which form part of the electronic equipment 23. The electronic circuitry units 29 each have actuators for insertion and ejection of the units 29, for instance a lever 27 mounted at each terminal end of a unit 29. The lever 27 pivots about an axis that is generally parallel to the plane of the faceplate of an electronic circuitry unit 29. Lever 27 is moveable between an open position (not shown), which permits removal of the unit 29, and a closed position (shown in FIG. 1), which secures the unit 29 to an equipment enclosure, described below. The clip 20a may be attached to a lever 27 of an electronic circuitry unit 29 to secure the clip 20a and thereby to limit movement of the cable 22 retained therein.

The electronic equipment 23 comprises an equipment enclosure which may be in the form of a box-shaped housing 31. The housing 31 may be used to house equipment such as the electronic circuitry units 29. A portion of the housing 31 is open providing access to one or more shelves 33 each of which holds the electronic circuitry units 29 in a side-by-side relationship. When installed into the housing 31, one or more of the electronic circuitry units 29 may be connected to a communications network 25 using the fiber optic cable 22. The fiber optic cable 22 carries communication signals between the electronic equipment 23 and the communications network 25. In the illustrative embodiment, the clip 20a may be used to guide the cable 22 from a vertical orientation as it depends from the electronic circuitry unit 29, to a horizontal orientation, directing the cable 22 towards a vertical edge 35 of the front face 37 of the housing 31. To guide the cable 22 towards the opposite vertical edge 39 of the front face 37 of the housing 31, a clip 20b, which has the mirror configuration of the clip 20a, may be used.

The housing 31 is typically attached to a rack (not shown). Several racks may be lined up side by side and organized into parallel rows, also called equipment line-ups (not shown). Each row is separated from the other by a predetermined distance which provides access to the electronic equipment 23 so that the equipment 23 may be serviced.

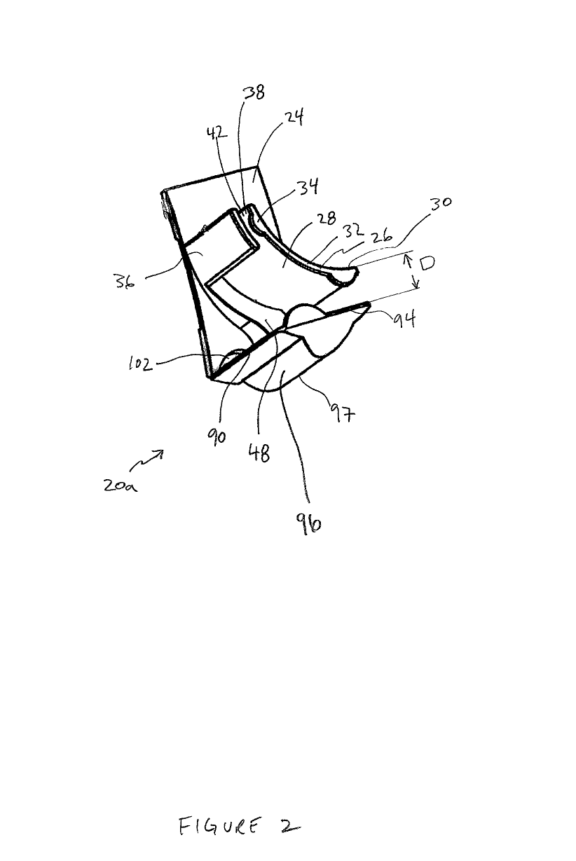

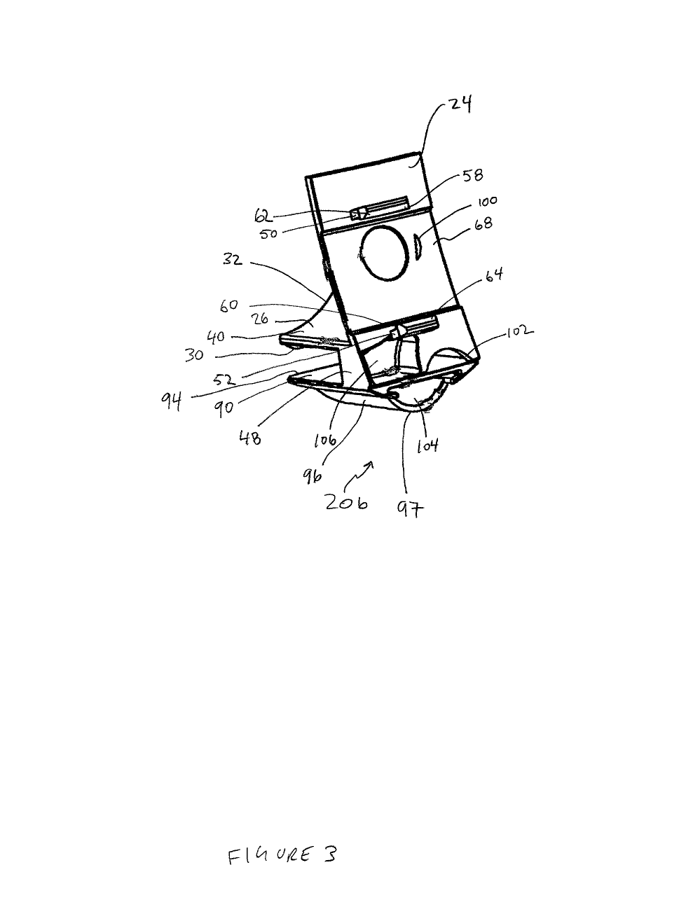

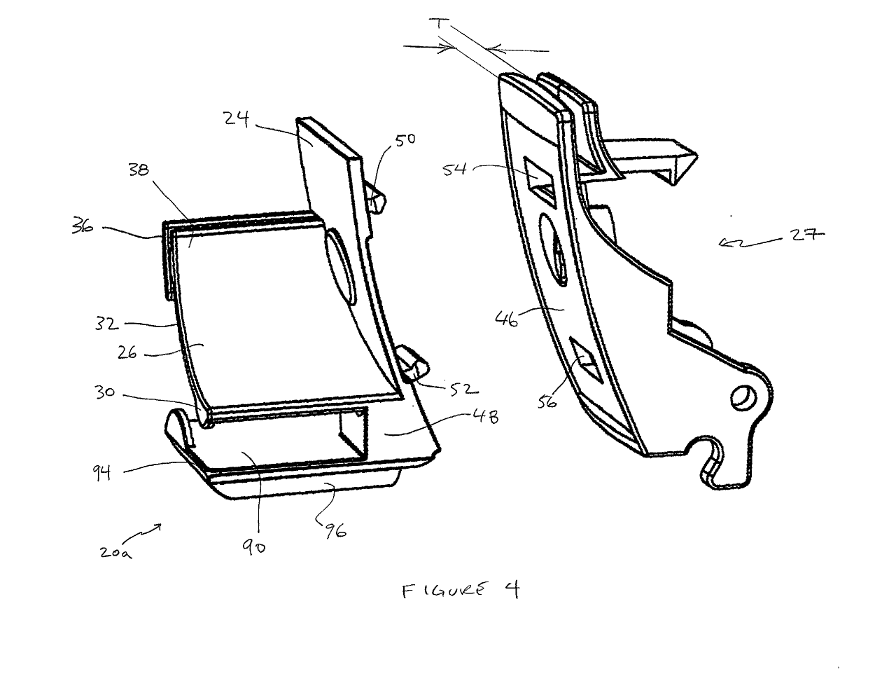

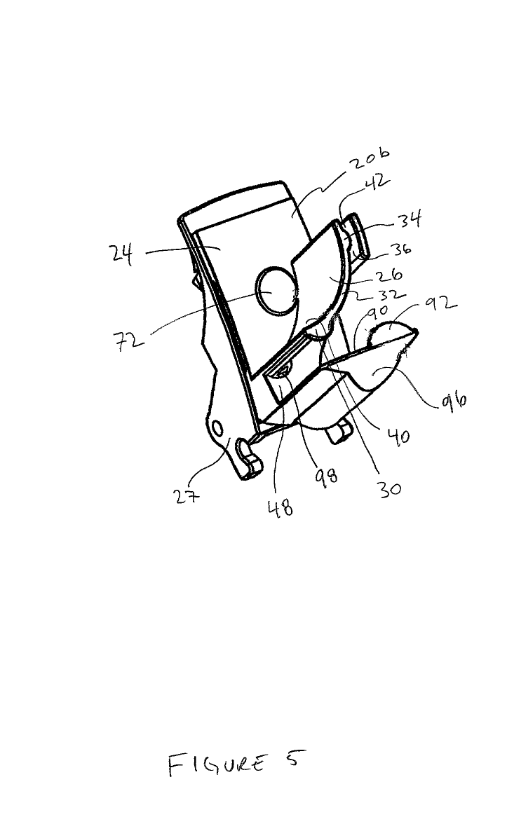

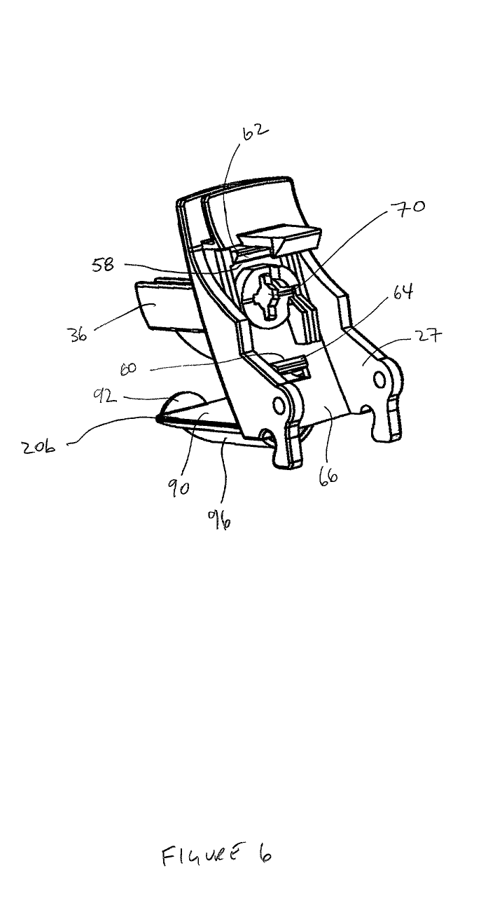

Referring now to FIGS. 2 through 5, which show various views of an illustrative embodiment of the present invention, the clip 20a, 20b has a plate-like member 24. A guiding member 26, that has at least one convex surface to form a curved boundary or guide, is located adjacent the plate-like member 24. In the case of the first illustrative embodiment of the invention, the convex surface is defined by a single surface 28. The convex curved surface 28 may be oriented generally perpendicular to the plane of the front face 37 of the housing 31, when the clip 20a, 20b is deployed with the housing 31 for cable management. The cable 22 contacts and is guided along the curved surface 28, causing the orientation of the cable 22 to be redirected while maintaining the cable 22 at a bend radius which is no less than a predetermined radius of curvature.

To minimize or avoid the possibility of fiber fracture in the cable 22 and to facilitate compliance with Bellcore bend radius standards such as standard R5-34 [170] from Generic Requirements document GR-78-CORE, the above-mentioned predetermined radius of curvature is at least one inch. In the first illustrative embodiment, the curved surface 28 forms a 90 degree arc. By maintaining a radius of curvature of at least one inch through a 90 degree arc, the clip 20a, 20b may be used to direct the cable 22 from a generally vertical orientation to a generally horizontal orientation while reducing the possibility of fiber fracture in the cable 22 by compliance with the previously mentioned Bellcore standard. In this configuration, the curved surface 28 has a longitudinal end 38 that is vertically above its other longitudinal end 40, when the clip 20a, 20b is positioned on the lower of two actuators typically found adjacent the terminal ends. The curved surface 28 of the clip 20a, 20b may alternatively be configured to have a larger or smaller arc of curvature, thus affecting the extent to which the orientation of the cable 22 is redirected.

In the first illustrative embodiment, the curved surface 28 of the guiding member 26 has a uniform length and width. The thickness of the guiding member 26 is also uniform and is thin relative to the length and width of the curved surface 28. The guiding member 26 is connected to the plate-like member 24 along one of the guiding member's longitudinal edges. At least one retaining member 30 depends from the free or distal longitudinal edge 32 of the guiding member 26. In an illustrative embodiment, the retaining member 30 may be oriented perpendicular to the convex curved surface 28. The retaining member 30 discourages the cable 22 from sliding off the curved surface 28. The retaining member 30 is preferably rounded or semi-circular so that it is less likely to catch on the cable 22 causing damage to the cable 22. While the retaining member 30 may be located at any point along the free longitudinal edge 32, it is preferably located at one end of the edge 32 with a second retaining member 34 located at the remaining end of the edge 32. This arrangement impedes lateral movement of the cable 22 across the curved surface 28 and past the free edge 32 of the guiding member 26. Lateral movement of the cable 22 is prevented in the opposite direction by the plate-like member 24. In an alternative embodiment, several retaining members may be applied to further impede movement of the cable 22. Alternatively, one retaining member, that traverses the entire free edge 32 of the curved surface 28, may be used.

A third retaining member 36 depends from the plate-like member 24 and this third retaining member 36 may preferably be provided with a curved cross-section such that the member 36 may be positioned substantially parallel to the curved surface 28. The third retaining member 36 is displaced from the curved surface 28 by a distance equivalent to at least the diameter of the cable 22. This distance permits the cable 22 to traverse the curved surface 28 with the third retaining member 36 inhibiting movement of the cable 22 in a direction normal to the convex curved surface 28. The second retaining member 34 is preferably located proximal to the higher longitudinal end 38 of the curved surface 28, with the third retaining member 36 positioned to correspond to the location of the second retaining member 34. In this configuration, the second retaining member 34 is smaller than the first retaining member 30, so that a cable 22 may pass, almost uninhibited, in a direction transverse to its longitudinal axis between the rounded portion of the second retaining member 34 and the third retaining member 36.

The guiding member 26 is preferably made from a flexible resilient material, such as a plastic. The resiliency of the guiding member 26 permits easy installation of the cable 22 into the clip 20a, 20b. When installing the cable 22, the guiding member 26 must be bent slightly away from the third retaining member 36 to permit sufficient room for the cable 22 to pass between the second and third retaining members 34, 36. The cable 22 is retained because the distance between the apex of the rounded portion of the second retaining member 34 and the corresponding surface of the third retaining member 36 is slightly less than the diameter of the cable 22. The second retaining member 34, third retaining member 36, plate-like member 24 and curved surface 28 thus form a cable channel 42 into which the cable 22 is locatable. The cable 22 may similarly be removed from the cable channel 42 by bending guiding member 26 and removing the cable 22. In an alternative to the first illustrative embodiment, the cable channel 22 may be formed by having the second retaining member 34 depend from the third retaining member 36, instead.

In the first illustrative embodiment, only one retaining member 36 is used to impede movement of the cable 22 in a direction normal to the convex curved surface 28 because the cable 22, once installed, will typically be tensioned longitudinally. This tensioning causes the cable 22 to be held against the curved surface 28, reducing the need for cable support elsewhere. The retaining member 36 is used to retain the cable 22 within the clip 20a, 20b when tension in the cable 22 is released, for example, when the cable 22 is disconnected at one end from an electronic circuitry unit 29 for servicing.

In an alternative to the first illustrative embodiment of the claimed invention, several retaining members 36 may be used to further impede movement of the cable 22 in a direction normal to the convex curved surface 28. Alternatively, the retaining member 36 may be constructed so that it has a concave curved surface (not shown), which runs parallel to the curved surface 28 for substantially the whole of the length thereof, and is uniformly displaced from the curved surface 28 by a distance equivalent to at least the diameter of the cable 22. The concave curved surface may alternatively be shortened to run parallel to only a portion of the convex curved surface 28, being preferably located opposite the convex curved surface 28 at the point at which the cable 22 enters the cable channel 42 when it has a vertical orientation. In either case, the cable 22 is introduced into and retained by the cable channel 42 in the manner described above.

The curved surface 28 and third retaining member 36 may extend from the plate-like member 24 to accommodate more than one, and preferably four, cables 22, in a side-by-side relationship, with each cable 22 dressed generally longitudinally along the curved surface 28. Each of the four cables 22 is inserted into the cable channel 42 one at a time, in the manner described above, with the last cable 22 to be inserted being retained by the second cable retaining member 34. All cables 22 are retained by the third retaining member 36. By limiting the projection of the curved surface 28 and third retaining member 36 to the equivalent of four cable diameters, the clip 20a, 20b projects from the front face 37 of the housing 31 less than or equal to approximately 0.5 inches. This limited projection provides more room between equipment lineups for service personnel than would be made available by some prior art cable management apparatus and should make the clip 20a, 20b less prone to catch on equipment and clothing of repair personnel, when compared to the said prior art apparatus.

As mentioned above, the clip 20a, 20b may be configured to attach to an actuator or lever 27 of an electronic circuitry unit 29. Compared to the prior art, this makes available more of the limited vertical space within the box-shaped housing 31 because the clip 20a, 20b is mounted to the front of the electronic circuitry unit 29 and not below it. To accomplish this attachment, the plate-like member 24 is generally rectangular in shape so that it is congruent with the generally rectangular surface 46 of the lever 27. The plate-like member 24 is also preferably curved along its longitudinal axis to conform to the convex curved surface 46 of the lever 27. The curvature of the plate-like member 24 does not affect the dimensions of the cable channel 42, because a generally wedge-shaped filler section 48 is provided adjacent the curved surface 28 and platelike member 24. The filler section 48 prevents the cable 22 from following the contour of the curved plate-like member 24. Instead, the filler section 48 provides a surface, which is generally parallel to the front face 37 of the housing 31, for the cable 22 to traverse as the cable 22 follows the curved surface 28 longitudinally. The filler section 48 thus minimizes lateral displacement of the cable 22. In other words, this lateral displacement is a displacement of the cable 22 in a direction normal to the plane of the faceplates of the electronic circuitry units 29.

Protruding generally perpendicular to the plate-like member 24, and from that side of the plate-like member 24 which is opposite to the curved surface 28 thereof, are provided at least one, and preferably two, fasteners, such as catches 50, 52. The catches 50, 52 are generally rectangular in cross-section and correspond in shape and orientation to two apertures, for instance slots 54, 56, located in the surface 46 of the lever 27. The catches 50, 52 are aligned along, and are symmetrical about, the longitudinal axis of the plate-like member 24. The free or distal ends of the catches 50, 52 have protrusions, for instance lips 58, 60. The lips 58, 60 extend from the surfaces of the catches 50, 52 that face each other. The lips 58, 60 are located at a distance from the plate-like member 24 equal to at least the thickness T of the lever 27. The further the lips 58, 60 are located from the plate-like member 24, the looser the fit will be between the clip 20a, 20b and the lever 27. It is therefore preferable that the distance is approximately the thickness T without being less than the thickness T, to ensure a secure fit between the clip 20a, 20b and the lever 27. This permits the lips 58, 60 to contact the inside surface 66 of the lever 27 when the catches 50, 52 are completely inserted into the slots 54, 56. To make it easier to insert the catches 50, 52 into their respective slots 54, 56, the free ends of the catches may be tapered. The catches 50, 52 are preferably made from a flexible resilient material, such as a plastic.

To attach the clip 20a, 20b to the lever 27, the tapers 62, 64 of the catches 50, 52 are brought into alignment with the respective slots 54, 56 in the lever 27. As the catches 50, 52 are inserted into the slots 54, 56, the tapers 62, 64 each contact an edge of the slot 54, 56. As the catches 50, 52 are further inserted, the tapers 62, 64 cause the free ends of catches 50, 52 to bend due to the protruding lips 58, 60. Once the lips 58, 60 pass the inside surface 66 of the lever 27, the catches 50, 52 straighten again due to the resiliency of the material from which they are made. The lips 58, 60 may then contact the inside surface 66 of the lever 27 to secure the clip 20a, 20b to the lever 27. The clip 20a, 20b may be manually removed from the lever 27 by exerting force on the clip 20a, 20b in a direction away from the lever 27.

To make the plate-like member 24 more flexible, the mid-section 68 of the plate-like member 24 may be made thinner than the remainder of the plate-like member 24. By making the plate-like member 24 thinner at mid-section 68 thereof, the plate-like member 24 may be more easily bent permitting the free ends of the catches 50, 52 to be more precisely guided into the slots 54, 56. The plate-like member 24 is preferably made from a flexible resilient material, such as a plastic, which causes the plate-like member to 24 regain its shape once the clip 20a, 20b is attached to the lever 27. The mid-section 68 also permits the clip 20a, 20b to be more easily removed by detaching one of the catches 50 or 52 at a time. If the plate-like member 24 were not flexible, then the catches 50, 52 would have to be removed at the same time, requiring greater force.

When the lever 27 is in the closed position, the electronic circuitry unit 29 is secured within the box-shaped housing 3. To remove an electronic circuitry unit 29 from the housing 31, the lever 27 must be unlocked. The lever 27 is unlocked by inserting a key (not shown) through a key-hole 70 in the lever 27. When the clip 20a, 20b is attached to the lever 27 the keyhole 70 cannot be accessed. A raised circular portion 72 of the plate-like member 24 obstructs access to the key-hole 70 and is located on the same side of the plate-like member 24 as the guiding member 26. The size and location of the circular portion 72 serves as a reminder to service personnel that they must first remove the clip 20a, 20b before servicing the electronic circuitry units 29.

Because the clip 20a, 20b retains cables 22, even when the clip 20a, 20b is not attached to the lever 27, the cables 22 associated with a particular electronic circuitry unit 29 are kept together when the clip 20a, 20b is removed from the electronic circuitry unit 29 for servicing. By keeping the cables 22 associated with an electronic circuitry unit 29 together, repair personnel are less likely to make mistakes when reattaching cables. This is especially true when several electronic circuitry units 29 are serviced at a time. Furthermore, the clips 20a, 20b are less likely to be misplaced or lost because they remain connected to the cables 22 during servicing of the electronic circuitry units 29.

Referring to FIG. 1, the preferred steps to complete a typical installation of the clip 20a, 20b are now described. The fiber optic cable 22 protrudes from the front face 37 of the housing 31 at or near its point of connection with the electronic circuitry unit 29. The fiber optic cable 22 typically hangs generally vertically over a portion of the front face 37 of the housing 31. Proximate to a lower portion of the housing 31, the cable 22 may be inserted into the cable channel 42 of a clip 20a, 20b, in the manner described above. The clip 20a, 20b is then attached to a lever 27 associated with the electronic circuitry unit 29 to which the cable 22 is attached. In the illustrative embodiment, up to four cables 22 may be retained by the clip 20a, 20b. The curved surface 28 of the clip 20a, 20b, which the cable 22 follows, causes the cable to change from a vertical orientation to a horizontal orientation, so that it may then be drawn horizontally across the front face 37 of the housing 31. As the cable 22 is drawn horizontally, the cable 22 is tensioned longitudinally, causing the cable 22 follow the curved surface 28 more closely. Tensioning also encourages the cable 22 to stay substantially in a plane parallel with the front face 37 of the housing 31. This minimizes the extent to which the cable 22 bends.

As illustrated in FIG. 1, multiple clips 20a, 20b may be used to guide cables 22 associated with different electronic circuitry units 29. Advantageously, only as many clips 20a, 20b as are required need be installed. In contrast, known cable management systems require that an entire set of cable management members be installed, whether they are used or not. In addition to requiring more material to construct the prior art cable management apparatus, space in and around the housing 31 is unnecessarily occupied by unused guide members.

The clip 20a, 20b may be provided with a supporting member, for instance a shelf 90. The shelf 90 is used to support cables 22 retained by other clips 20a, 20b. The shelf 90 preferably has a generally planar rectangular shape and is located adjacent and perpendicular to the plane of the front face 37 of the housing 31. The shelf 90 may be positioned with its planar surface oriented horizontally and directly below the guiding member 26, at a distance D from the lower longitudinal end 40 of the curved surface 28. The distance D is preferably wider than the diameter of the cable 22. In the first illustrative embodiment, this distance may be equivalent to the diameter of at least two cables 22. The shelf 90 extends from the plate-like member 24 a sufficient distance to accommodate more than one, and preferably four, cables 22, in a side by side relationship with each cable 22 dressed horizontally and supported by the shelf 90.

The shelf 90 beneficially supports cables 22 to alleviate or minimize excessive bending or other mechanical disruption of the cables. As shown in FIG. 1, the shelf 90 may be used to support a particular cable 22, even though the clip 20b with which the shelf 90 corresponds does not retain that particular cable 22 as well. This is explained in greater detail below.

The shelf 90 may have a retaining member, for instance a tab 92, to discourage the cable 22 from sliding off the shelf 90. The tab 92 may be rounded or semi-circular so that it is less likely to catch on and damage the cable 22. In the illustrative embodiment, the tab 92 extends from the longitudinal free edge 94 of the shelf 90 and extends perpendicular to the shelf 90 towards the curved surface 28.

While the shelf 90 should be made of sufficiently rigid material to support at least one cable 22, additional support may be provided by a shelf support member 96 which is attached to the plate-like member 24 and to the underside of the shelf 90. An edge 97 of the shelf support member 96, located on the side of the shelf support member 96 that is farthest from the shelf 90, may be rounded. For installations of the clip 20a, 20b where the levers 27 are not locked, the rounded support member 96 acts as a pry to remove the clip 20a, 20b from the lever 27 when the lever 27 is moved to an open position. This occurs because the rounded edge 97 extends below the axis (not shown) about which the lever 27 pivots. When the lever 27 is pivoted to an open position, the rounded edge 97 is forced towards the front face 37 of the housing 31. The rounded edge 97 then contacts and is stopped by the front face 37. This places a force on the clip 20a, 20b that opposes the force causing the lever 27 to open. Compression of the clip 20a, 20b results and the catches 50, 52 are forced to release and the clip 20a, 20b detaches from the lever 27 while still retaining the cable 22. If the clip 20a, 20b does not automatically pry from the lever 27, then the cables 22 retained by the clip 20a, 20b would be twisted and potentially damaged by the movement of the lever 27, unless the clip 20a, 20b is detached from the lever 27 prior to actuation of same to its open position.

An illustrative example of how a cable 22 is guided by a first clip 20a′ and supported by a second clip 20a″, follows. A cable 22 retained by a first clip 20a′ is guided from a vertical orientation to a horizontal orientation. Once horizontal, the cable 22 traverses a horizontal distance between the first clip 20a′ and the second clip 20a″. As the cable 22 is dressed towards a vertical edge 37 of the housing 31, the cable 22 is placed on, and supported by, the horizontal shelf 90 of the second clip 20a″. As illustrated in FIG. 1, many different clips 20a′, 20a″, 20b may be used to both guide and retain cable 22, while at the same time supporting cable 22 guided and retained by other clips 22a′, 20a″, 20b. Since the structure of a clip according to the first embodiment of the invention is such that the distance D is greater than the diameter of a cable 22, the cables 22 retained by the second clip 20a″ are less likely to interfere with the positioning of the cables 22 that are supported by the shelf 90 of the second clip 20a″, when compared to a structure having the distance D being less than or the same as the diameter of a cable 22. Constructing the clips 20a, 20b with a greater distance D leads to less interference between those of the cables 22 which are supported but not retained by a clip 20a, 20b and those other of the cables 22 which are retained by the same clip 20a, 20b.

As the above description illustrates, the clip 20a, 20b advantageously provides a means for retaining, guiding and supporting one or more cables 22, and it provides bend radius control so that the cable 22 does have a bend radius of less than one inch.

The clip 20a, 20b may be constructed as an integrally formed unit by injection molding, as is known to those skilled in the art. A plastic with the necessary resiliency and flexibility described above, should be used. The clips 22a, 22b may alternatively be made of other materials, such as metals, having suitable properties.

To facilitate injection moulding, the clips 20a, 20b have holes 98, 100, 102 provided therein. The holes 98, 100, 102 permit passage of moulding members (not shown) used to form retaining members 30, 34 and tab 92. The holes 98, 100, 102 are the same shape and area as the longitudinal cross-sections, taken in a plane generally parallel to the plate-like member 24, of the corresponding retaining members 30, 34 and tab 92.

To save construction materials, voids 104 and 106 are made by the injection moulding apparatus (not shown) in the interior of the filler section 48 and shelf support member 96. The voids 104, 106 open only to the side of the plate-like member 24 with the catches 50, 52 and do not affect the above-described functionality of the clip 20a, 20b.

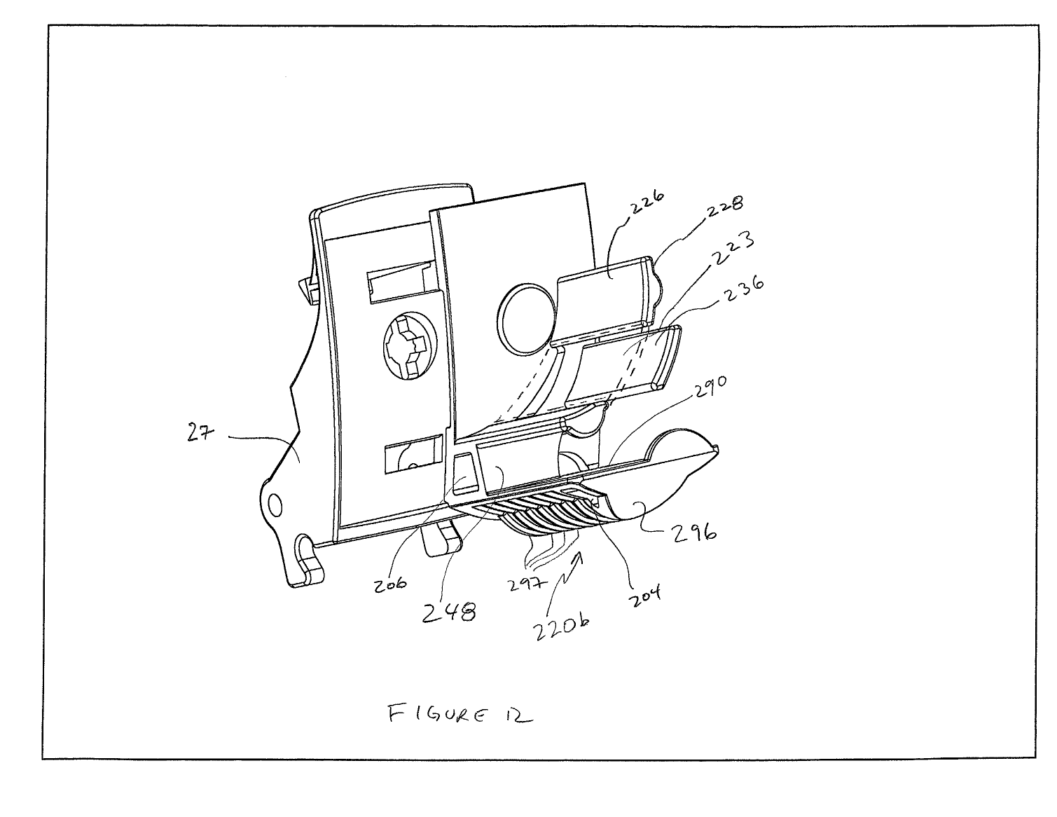

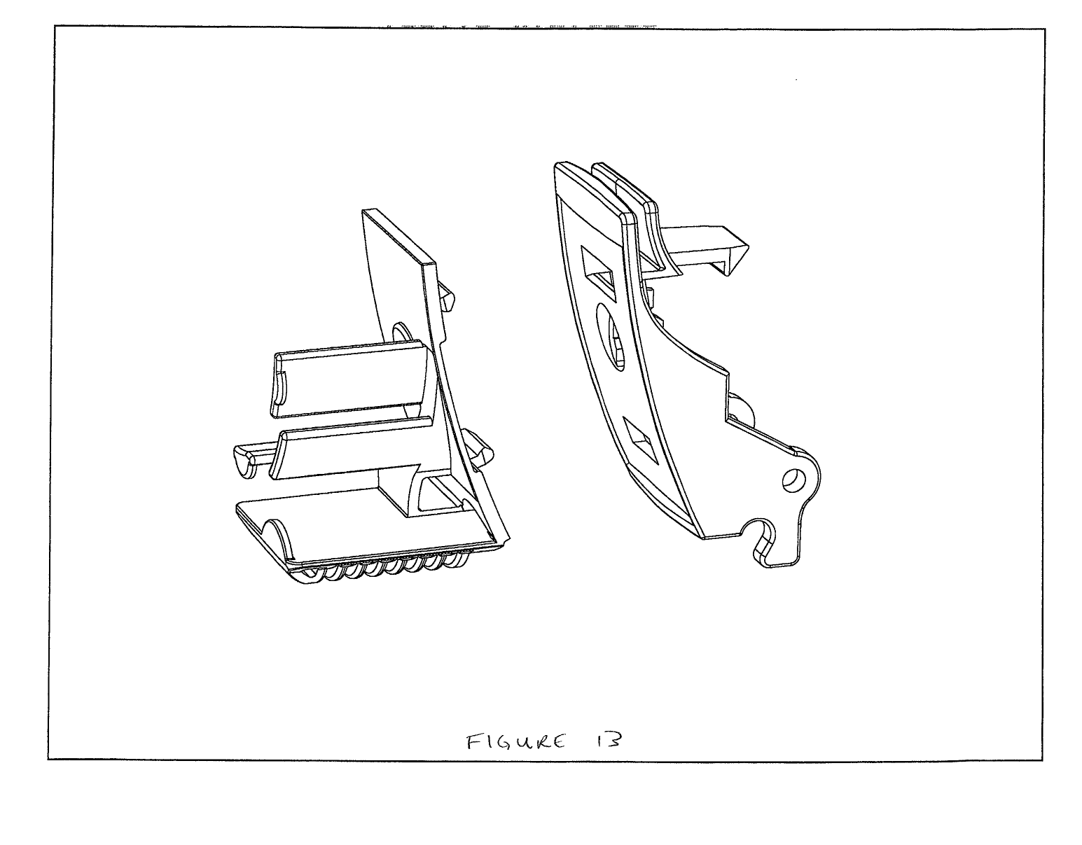

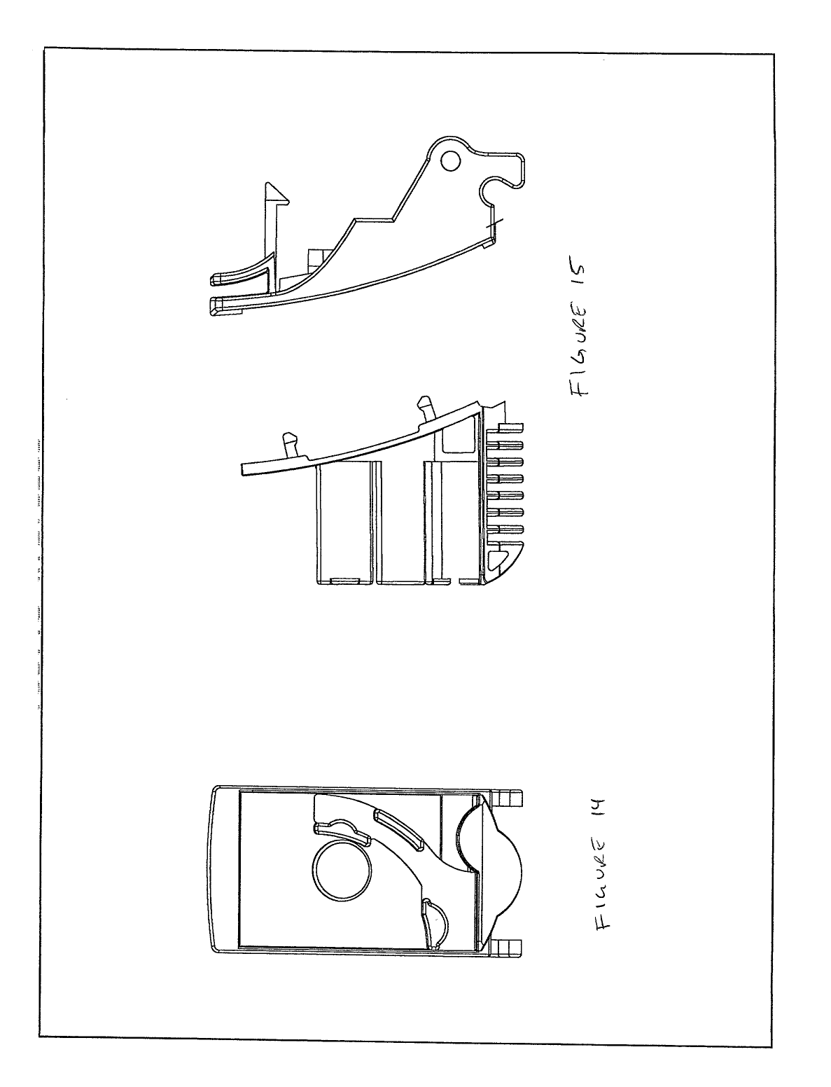

Referring to FIG. 12, in a second illustrative embodiment, the clip 220b (the clip in mirror configuration is not shown) may be configured in the same manner as the clip 20 of the first embodiment but with sections of the clip 20 effectively removed. By forming the clip 220b in this manner, injection moulding may be achieved with the mould members (not shown) moving in a direction generally perpendicular to an axis which is aligned with the direction of extension of the shelf 290 away from plate-like member 224. In contrast, the clip 20 may be moulded with the mould members oriented parallel to the same axis associated with the shelf 90 while moving in a direction parallel thereto. (The numbering of the elements of the second embodiment is the same as the first embodiment except that the reference numerals for corresponding elements in the second embodiment have the prefix “2”.)

To facilitate the moulding of clip 220b, a section 223 of the guiding member 226, shown in stippled lines in FIG. 12, is not moulded. This permits an alternative moulding of the retaining member 236. Unlike the first embodiment, the retaining member 236 is located so that it does not correspond with an end of the guiding member 226. The cable 22 is therefore still supported by guiding member 226 even though section 223 has been eliminated.

To save construction materials, filler section 248 may have a void 206 therethrough. In the second embodiment, the shelf support member 296 may have a void therein, or it may instead have grooves 297 which are perpendicular to the above-mentioned axis of the shelf 290. The grooves 297 reduce the amount of construction material required to make the clip 220. A void 204 may also be provided in the support member 296.

The modifications to the structure of the first embodiment as reflected in the second embodiment do not significantly affect the functionality of the clip 220b, which is the same as described above for clip 20.

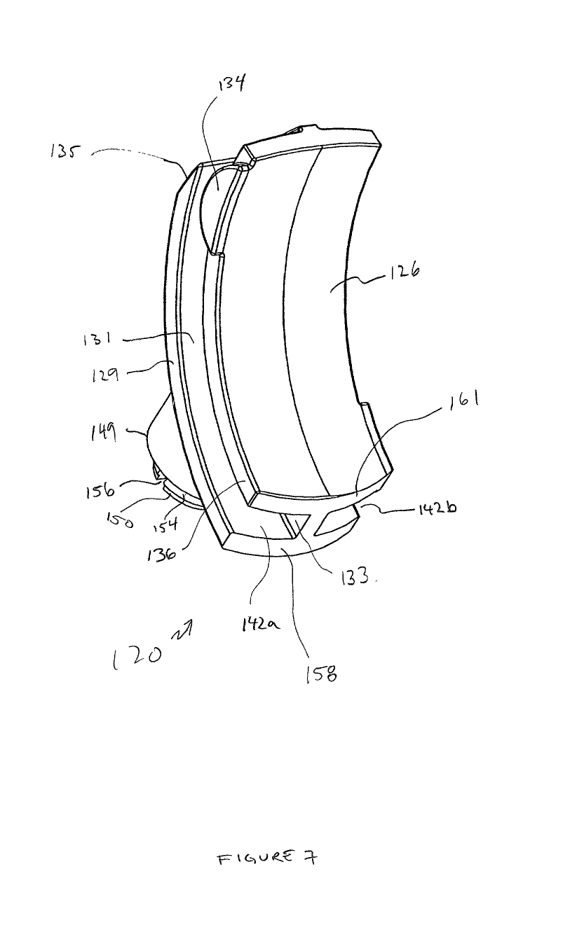

Referring to FIGS. 7, 8 and 9, various views of a third illustrative embodiment of the invention are shown. The third embodiment is a cable bend radius control apparatus similar to the first illustrative embodiment. The cable bend radius control apparatus is in the form of a clip 120 which is used to guide and retain at least one signal carrying cable 22 at a predetermined radius of curvature. The clip 120 may be installed in an environment similar to that described above for the clip 20a, 20b. The cable 22 is typically connected to electronic equipment 23. The cable is fiber optic cable 22 which connects a communications network 25 to plug-in electronic circuitry units 29 which form part of the electronic equipment 23. The clip 120 may be attached proximate to an electronic circuitry unit 29 to limit movement of the cable 22 and to secure the clip 20a.

In the third illustrative embodiment, the clip 120 may be used to guide the cable 22 from a vertical orientation as it depends from the electronic circuitry unit 29, to a horizontal orientation, directing the cable 22 towards a vertical edge 35 of the front face 37 of the housing 31. To guide the cable 22 towards the opposite vertical edge 39 of the front face 37 of the housing 31, the clip 120 is rotated and installed so that it may direct the cable 22 towards the opposite vertical edge 39, as described below.

The clip 120 has a first guiding member 126 that has a convex curved surface 128. The clip 120 also has a second guiding member 129 that has a concave curved surface 131, which runs parallel to the curved surface 128, and is uniformly displaced from the curved surface 128 by a distance equivalent to at least the diameter of the cable 22. The convex curved surface 128 and concave curved surface 131 are connected by a spacing member, for instance a web 133, located therebetween. The web 133 may be perpendicular to the curved surfaces 128, 131 and preferably bisects them longitudinally. The guiding members 126, 129 may be identical in shape and size, each having a substantially uniform length and uniform width, with a thickness that is small relative to the length and width.

The cable 22 contacts and is guided along at least one of the curved surfaces 128, 131, causing the orientation of the cable 22 to be redirected while maintaining the cable 22 at a bend radius which is no less than a predetermined radius of curvature. According to an illustrative embodiment, the predetermined radius of curvature complies with Bellcore standard R5-34 [170], as discussed above for the first embodiment.

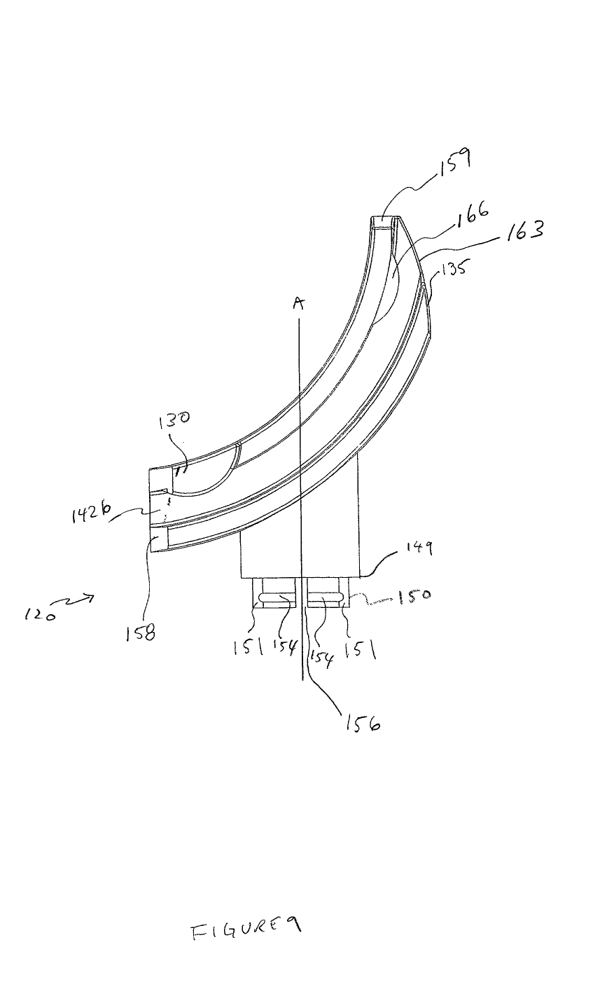

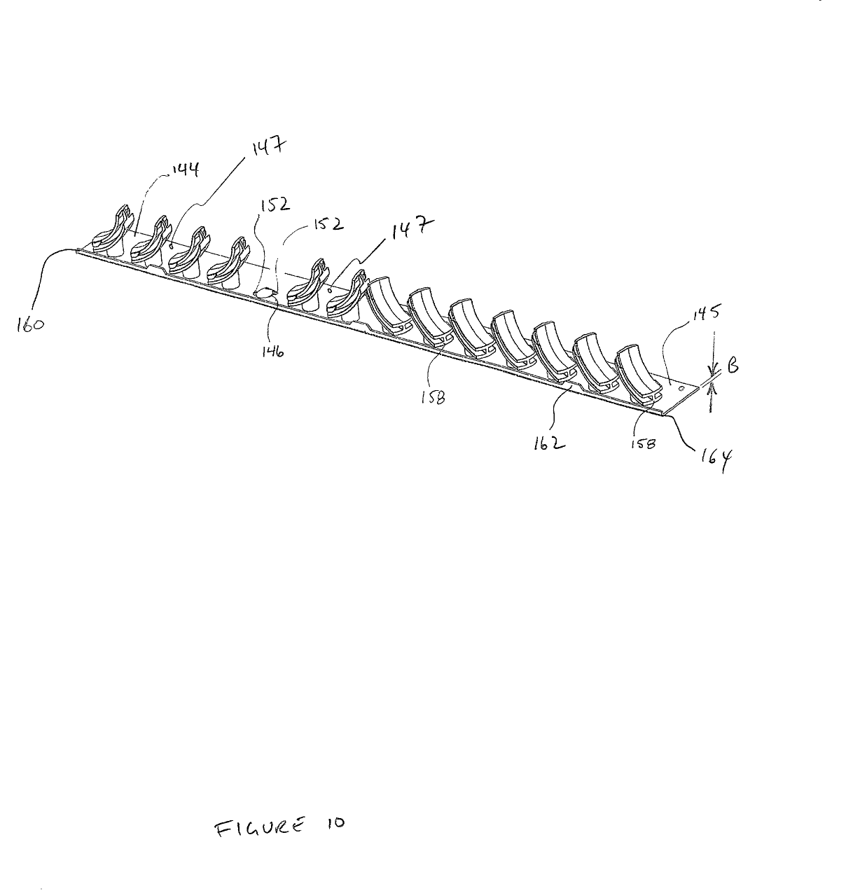

According to the third illustrative embodiment, the curved surfaces 128, 131 may each traverse a 90 degree arc and are oriented so that the clip 120 directs the cable 22 from a generally vertical orientation to a generally horizontal orientation, as previously explained in relation to other illustrative embodiments. The curved surfaces 128, 131 of the clip 120 may alternatively be configured to have a larger or smaller arc of curvature, thus affecting the extent to which the orientation of the cable 22 is redirected. To reduce the horizontal space occupied by the clip 120 when it is installed as shown in FIG. 10, the second guiding member 129 may be shortened longitudinally (best seen in FIG. 9) at its end 135 where the cable 22 enters the clip 120 when the cable 22 has a vertical orientation. To further reduce the horizontal space occupied by the clip 120, the first guiding member 126 and second guiding member 129 may both be shortened longitudinally at their opposite ends 158.

At least one retaining member 130 depends from a longitudinal edge 132 of the guiding member 126. According to the third illustrative embodiment, the retaining member 130 may be oriented parallel to the plane of web 133. The retaining member 130 discourages the cable 22 from sliding off the curved surface 128. The retaining member 130 may be rounded or semicircular so that it is less likely to catch on the cable 22 causing damage to the cable 22.

At least one other retaining member 134 depends from the other longitudinal edge 136 of the guiding member. The other retaining member 134 may be oriented parallel to the plane of web 133. The retaining member 134 discourages the cable 22 from sliding off the curved surface 128. The retaining member 134 may be rounded or semi-circular so that it is less likely to catch on the cable 22 causing damage to the cable 22.

While the retaining members 130, 134 may be located at any point along the free longitudinal edges 132, 136, they are preferably located so that they are not each adjacent and opposite to one another at respective corresponding locations found along the free longitudinal edges 132, 136. This arrangement makes it easier to manufacture the clip 120 by injection moulding. In the third illustrative embodiment, the retaining members 130, 134 are located at opposite ends of the respective edges 132, 136. This arrangement impedes lateral movement of a cable 22 across the curved surfaces 128, 131 and past the free edges 132, 136 of the respective guiding members 126, 129. The web 133 also prevents lateral movement of the cable 22. In an alternative third embodiment, one or more retaining members (not shown) may be added to either or both edges 132, 136 to further impede lateral movement of the cable 22. Alternatively still, one or both of the longitudinal edges 132, 136 may each be provided with one retaining member that traverses the entire edge 132, 136. Similarly, the edges of guiding member 129 may be provided with one or more retaining members (not shown).

The free or distal ends of the retaining members 130, 134 may extend from the edges 132, 136 so that a cable 22 may pass uninhibited in a direction transverse to the cable's longitudinal axis, between the rounded portion of one of the retaining members 130, 134 and the concave curved surface 131. If the free ends of the retaining members 130, 134 extend so that they partially inhibit the cable 22, then a force transverse to the longitudinal axis of the cable 22 must be applied to the cable 22 to push it between the free end of a retaining member 130, 134 and the concave curved surface 131.

According to the third illustrative embodiment, the guiding members 126, 129 may be made from a flexible resilient material, such as a plastic. The resiliency of the guiding members 126, 129 facilitiates installation of a cable 22 into the clip 120. When installing the cable 22, one or both of the guiding members 126, 129 must be bent slightly away from the other guiding member 126, 129 to permit sufficient room for the cable 22 to pass between one of the retaining members 134, 136 and the concave curved surface 131. The cable 22 is retained because the distance between the apex of the rounded portion of the retaining members 134, 136 and the corresponding curved surface 131 is preferably slightly less than the diameter of the cable 22. The retaining members 134, 136, and curved surfaces 128, 131 thus form a cable channel 142 into which the cable 22 is locatable. The web 133 bisects the channel 142 creating two parallel channels 142a and 142b. Channel 142a is defined by retaining member 134, curved surfaces 128, 131 and the web 133; and channel 142b is defined by retaining member 130, curved surfaces 128, 131 and the web 133.

The cable 22 may be removed from the cable channel 142a, 142b by bending one or both of the guiding members 126, 129 away from the other guiding member 126, 129 to permit sufficient room for the cable 22 to pass between one of the retaining members 134, 136 and the concave curved surfaces 128, 131. If the clip 120 is not made from a flexible material then the outer protective coating (not shown) of the fiber optic cable 22, may have to deform to permit installation of the cable 22 into a cable channel 142a, 142b. In this configuration, the free ends of the retaining members 130, 134 preferably extend from the edges 132, 136 to such degree that they require only that a portion of the thickness of the outer coating of the cable 22 be deformed to install the cable 22. This ensures that the inner optical fibers of cable 22 remain protected from deformation.

In the third illustrative embodiment, the cable 22, once installed, will typically be tensioned longitudinally. This tensioning causes the cable 22 to be held against the curved surface 128, reducing the need for cable support elsewhere. The guiding member 129, in conjunction with a retaining member 130, 134, is used to retain one or more cables 22 within the clip 120 when tension in the cable 22 is released, for example, when the cable 22 is disconnected at one end from an electronic circuitry unit 29 for servicing. In an alternative of the third embodiment of the claimed invention, the second guiding member 129 may have an arc of curvature which is less than that of the guiding member 126.

The curved surfaces 128, 131 may be sufficiently wide to accommodate more than one, and preferably four, cables 22, in a side-by-side relationship, with each cable 22 dressed longitudinally along the curved surfaces 128, 131. Two cables 22 may be located in cable channel 142a and two cables 22 may be located in cable channel 142b. Each of the four cables 22 is inserted into the respective cable channels 142a, 142b one at a time, in the manner described above, with the last cable 22 to be inserted in each channel 142a, 142b being retained by the associated cable retaining member 130, 134. By limiting the capacity of the clip 120 to the equivalent of four cable diameters, the clip 120 projects from the front face 37 of the housing 31 less than or equal to approximately 0.5 inches, when installed. When compared to the prior art, this limited projection provides more room between equipment line-ups for service personnel and also should make the clip 120 less prone to catch on equipment and clothing of repair personnel.

Referring additionally to FIG. 10, the clip 120 may be configured to attach to a trough 144. The trough 144 is generally planar with a uniform length and width. According to the third illustrative embodiment of the invention, the trough 144 may be the same length as the horizontal distance between the vertical edges 35, 39 of the housing 31, and is preferably less than or equal to approximately 0.5 inches wide. When installed, the planar surface 145 of the trough 144 may be oriented horizontally adjacent the front face 37 of the housing 31, between the vertical edges 35, 39, with its longitudinal axis parallel to the plane of the front face 37. The trough 144 may be attached to the shelf 33 so that it is generally horizontal, with the planar surface 145 of the trough 144 perpendicular to the plane of the front face 37 of the housing 31. The planar surface 145 may have at least one aperture, for instance a hole 147, therethrough for mounting the trough 144 to a shelf 33. Rivets or screws (not shown), for example, may be used to secure the trough 144 by using holes 147. The holes 147 may be aligned with one another along an axis parallel to the longitudinal axis of the trough 144.

Compared to the prior art, the location of the trough 144 makes available more of the limited vertical space within the box-shaped housing 31 because the clip 120 is mounted in front of the housing 31. The vertical space occupied by the trough 144 within the housing 31 is generally limited to its thickness B.

The trough 144 is provided with at least one aperture, for instance a substantially circular hole 146, for matingly receiving a connector of the clip 120. The holes 146 may be horizontally located along the same axis which is parallel to the longitudinal axis of the trough 144. Each hole 146 is located to correspond to an associated electronic circuitry unit 29, with the distance between the centres of each hole 146 being the same as the distance between corresponding electronic circuitry units 29. The holes 146 may be located close to the free end of the trough 144 to permit the cable channels 142a, 142b to be oriented at an angle to the front face 37 of the housing 31, as described below. Locating the holes 146 in this manner also may provide additional space on the trough 144 for the mounting of the trough 144 to a shelf 33.

The connector of a clip 120 may be a cylindrical post 148. According to the third illustrative embodiment, the post protrudes from the side of the second guiding member 129 opposite to the side connected to the web 133. The longitudinal axis A of the post 148 is preferably oriented at a 45 degree angle to an axis that is both normal to the curved surface 128 and passes through the longitudinal axis of the curved surface 128. The longitudinal axis A may also be coplanar with the web 133 and may pass through or near the centre of symmetry of the curved surface 128. Aligning the post 148 in this manner ensures that the curved surfaces 128, 131 are generally centred in relation to the electronic circuitry units 29 to which a cable 22 retained by the clip 120 is connected. This arrangement reduces the horizontal space occupied by the clip 120 and limits interference between clips 120 when two or more clips 120 are installed in close proximity to one another. Furthermore, cables 22 may be maintained in a generally vertical orientation as they traverse the front face 37 of the housing 31 between an electronic circuitry unit 29 and the clip 120. In addition to reducing potentially detrimental bending of cable 22, by keeping the cable 22 in a generally vertical orientation, interference with other cables 22 is reduced. Cables 22 are also less likely to interfere with the servicing of the electronic circuitry units 29.

The free end 150 of the post 148 has a circumference that is uniformly less than that of the post 148. The point at which the circumference of the post is reduced forms a circumferential shoulder 149. The diameter of the free end 150 is generally the same as that of the hole 146. When the free end 150 is inserted into the hole 146 shoulder 149 stops further insertion of the free end 150 into the hole 146. To inhibit rotational movement of the free end 150 within the hole 146 about axis A, the surface of the free end 150 may be provided with at least one longitudinal rib 151 running perpendicular to the circumference of the free end 150. If the clip 120 is permitted to pivot or otherwise move, then the cable 22 may unduly bend causing damage to it. The hole 146 may be provided with a corresponding rebate 152 for each longitudinal rib 151 of the free end 150. According to the third illustrative embodiment, two longitudinal ribs 151 are located opposite to one another on the free end 150. When the free end 150 is inserted into the hole 146, the longitudinal ribs 151 engage the rebates 152 and inhibit rotational movement of the post 148 within the hole 146.

The free end 150 may also be provided with a circumferential rib 154. The diameter of the free end 150 taken at the circumferential rib 154 is preferably greater than the diameter of the hole 146, whereas the diameter of the free end 150 is preferably the same or less than the diameter of the hole 146. The circumferential rib 154 may be located at a distance from the shoulder 149 equal to at least the thickness B of the trough 144. The further circumferential rib 154 is located from the shoulder 149, the looser the fit will be between the clip 120 and the trough 144. It is therefore preferable that the distance is approximately the thickness B without being less than the thickness B, to ensure a secure fit between the clip 120 and the trough 144. This permits the circumferential rib 154 to contact one surface of the trough 144 when free end 150 is completely inserted into the hole 146 with the shoulder 149 contacting the opposite surface of the trough 144. To make it easier to insert the free end of the post 150 into the hole 146, the post 148 may be bisected across its diameter by at least one groove 156. The groove 156 makes the post more flexible at the free end 150. Yet greater flexibility may be achieved by adding a similar groove (not shown) bisecting the post 148 along its diameter at a right angle to the first groove 156. Still greater flexibility in the free end 150 may also be achieved my making the groove 156 deeper in the direction of axis A of the post 148. The post 148 is preferably made from a flexible resilient material, such as a plastic.

To attach the clip 120 to the trough 144, the free end 150 of the post 148 is aligned with the hole 146. As the free end 150 is inserted into the hole 146, the circumferential rib 154 contacts an edge of the hole 146. As force is applied to the clip 120, directing its free end 150 into the hole, circumferential rib 154 causes the circumference of the free end 150 to be reduced, as permitted by the groove 156. The circumferential rib 154 then passes through the hole 146 and the circumference of the free end 150 returns to its original dimension due to the resiliency of the material from which the post 148 is made. The circumferential rib 151 may then contact the surface of the trough 144 to secure the clip 120 to the trough 144. The clip 120 may be manually removed from the trough 144 by exerting force on the clip 120 in a direction opposite to the direction of insertion.

The rebates 152 may be located so that the clip 120, once installed in the trough 144, is oriented with the cable channels 142a, 142b substantially parallel to the front face 37 of the housing 31. Alternatively, the rebates 152 may be located so that the clip 120 is angled as aforesaid about the longitudinal axis A of the post 148 causing the cable channels 142a, 142b to be at an angle, preferably a 15 degree angle with the front face 37 of the housing 31 and causing the end 135 of the guiding member 129 to be closer to the housing 31 (see FIG. 10). In this configuration, the clips 120 may be placed closer to one another while limiting the interference between the cable 22 retained by adjacent clips 120. If the clip 120 is rotated, then an end of the guiding members 126, 129, for example end 158, may project away from the front face 37 of the housing 31 and beyond the free edge of the trough 144. This projection may interfere with the equipment and clothing of service personnel. To address this potential problem, the end 158 may be rounded in a direction transverse to the longitudinal axes of the guiding members 126, 129 to form a convex curved surface 161. The opposite end may be similarly rounded in a direction generally perpendicular to the plane of the web 133 and perpendicular to the curve 161 to form a second convex curved surface 163. The rounding reduces the projection of the ends 158, 159 while substantially retaining the length of the guiding members 126, 129.

The holes 146 closest to a vertical edge 35 of the housing 31 have rebates 152 that are preferably located to cause the clip 120 to direct the cable 22 towards the vertical edge 35. Holes 146 closest to the other vertical edge 39 have rebates 152 located to cause the clip 120 to direct the cable 22 towards the edge 39.

Because the clip 120 retains cables 22, even when the clip 120 is not attached to the trough 144, the cables 22 associated with a particular electronic circuitry unit 29 are kept together when the clip 120 is removed from the electronic circuitry unit 29 for servicing. As noted above, by keeping the cables 22 associated with an electronic circuitry unit 29 together, repair personnel are less likely to make mistakes when reattaching cables. This is especially true when several electronic circuitry units 29 are serviced at a time. Furthermore, the clip 120 is less likely to be displaced because it remains connected to the cables 22 during servicing of the electronic circuitry units 29.

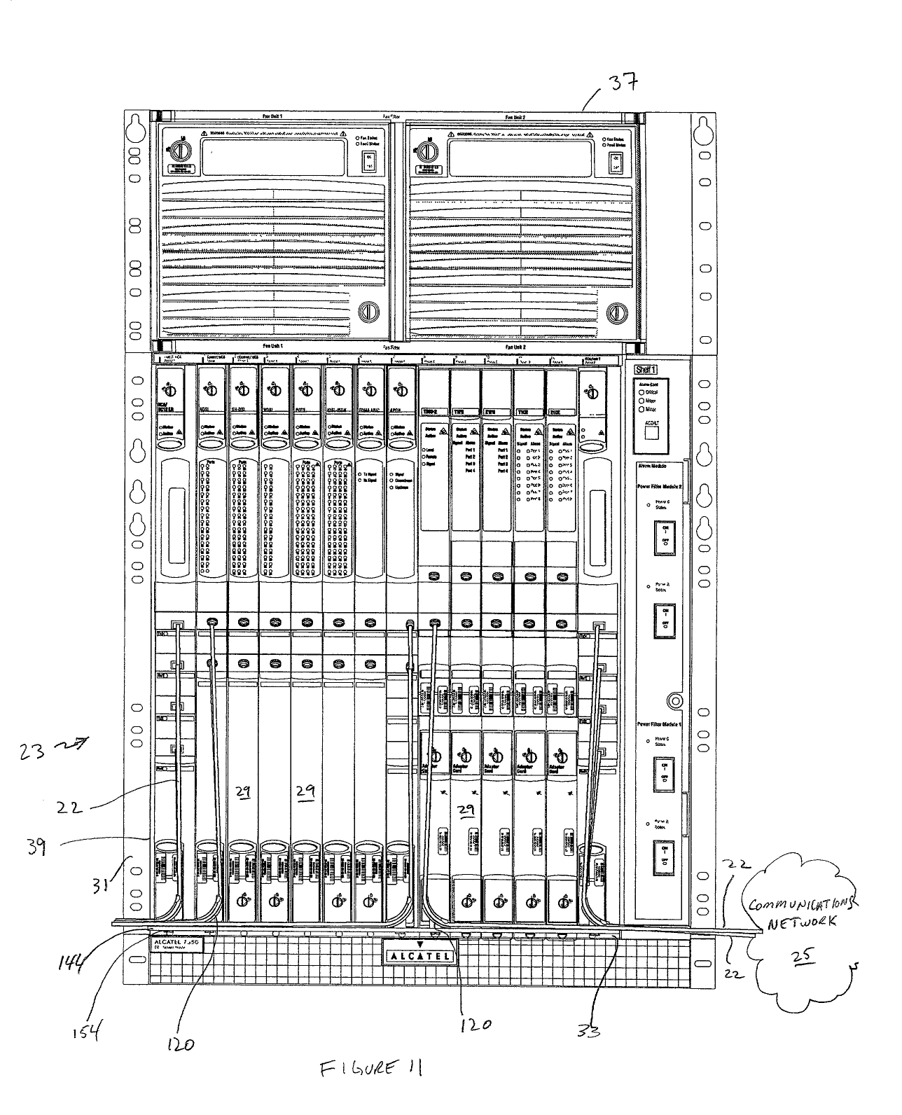

Referring additionally to FIG. 11, the preferred steps to complete a typical installation of the clip 120 are described. The fiber optic cable 22 protrudes from the front face 37 of the housing 31 at or near its point of connection with the electronic circuitry unit 29. The fiber optic cable 22 typically hangs generally vertically over a portion of the front face 37 of the housing 31. Proximate to a lower portion of the housing 31, the cable 22 may be inserted into a cable channel 142a or 142b of a clip 120, in the manner described above. The clip 120 is then attached to a trough 144 using a hole 146 associated with the electronic circuitry unit 29 to which the cable 22 is attached. In the third illustrative embodiment, up to four cables 22 may be retained by the clip 120. The curved surfaces 128, 131 of the clip 120, which the cable 22 may follow, cause the cable 22 to change from a generally vertical orientation to a generally horizontal orientation, so that the cable 22 may then be drawn horizontally across the front face 37 of the housing 31 towards one of the vertical edges 35, 39. The cable 22 is guided towards a particular edge 35, 39 by installing the clip 120 into a hole 146 in the trough 144. As the cable 22 is drawn horizontally, the cable 22 is tensioned longitudinally, causing the cable 22 to follow the curved surface 128 more closely. Tensioning also encourages the cable 22 to stay substantially in a plane parallel with the web 133. This minimizes the extent to which the cable 22 bends.

As illustrated in FIG. 11, multiple clips 120 may be used to guide cables 22 associated with different electronic circuitry units 29. As with the first embodiment, only as many clips 120 as are required need be installed, thus providing the benefits described earlier.

If the cable 22 is not sufficiently tensioned along its longitudinal axis, then the trough 144 supports the cable 22 as it horizontally traverses the front face 37 of the housing 31. The trough 144 may be of a width sufficient to accommodate more than one cable 22 in a side by side relationship with each cable 22 dressed horizontally and supported by the trough 144. The trough 144 supports cables 22 to alleviate or minimize excessive bending or other mechanical disruption of the cable. The trough 144 may also discourage cable 22 from interfering with the servicing of electronic circuitry units 29 that are located below the trough 144.

The trough 144 may have a retaining flange 160 or at least one retaining tab 162 to discourage the cable 22 from sliding off the trough 144. Alternatively, both a retaining flange 160 and tab 162 may be provided, as illustrated in FIG. 10. The flange 160 and tab 162 may also increase the rigidity of the trough 144. The flange 160 may traverse the trough 144 longitudinally and may be located along the free edge 164 of the trough 144. The tab 162 may be similarly located at the free edge 164 or may be located on the planar surface 145 of the trough 144. In either case, both the flange 160 and tab 162 extend upwards when the trough is mounted adjacent the housing 3 land may be perpendicular to the planar surface 145 of the trough 144.

The trough 144 should be made of sufficiently rigid material, such as sheet steel, to support at least one cable 22, and may be extruded or stamped, or constructed by some other means as is known in the art.

The clip 120 may be constructed as an integrally formed unit by injection molding, as is known to those skilled in the art. A plastic with the necessary resiliency and flexibility, as described above, should be used. The clip 120 may alternatively be made of other materials, such as metals, having suitable properties.

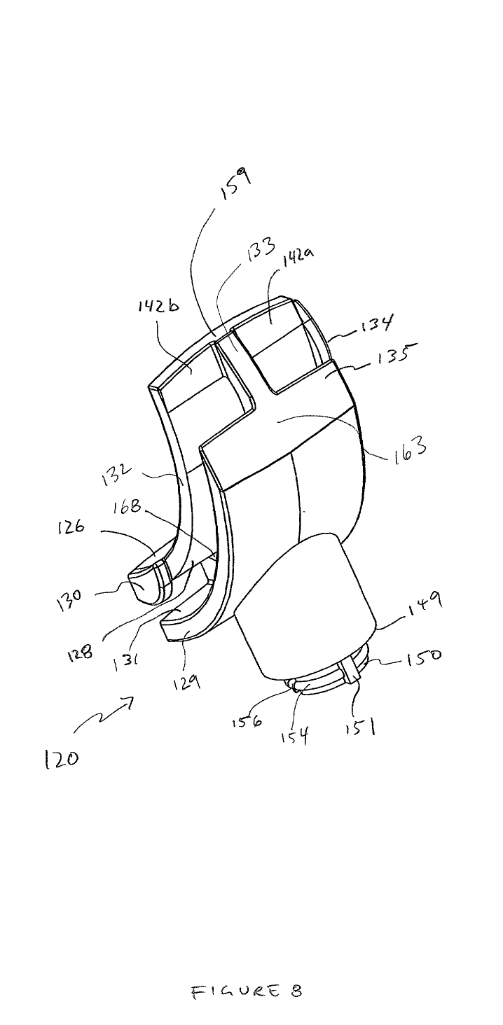

To facilitate injection moulding, the clip 120 has holes 166 and 168 (hole 168 is partially shown in FIG. 8). The holes 166, 168 permit passage of moulding members (not shown) used to form retaining members 130, 134. The holes 166, 168 are the same shape and area as the longitudinal cross-sections, taken in a plane parallel to the web 133, of the corresponding retaining members 130, 134.

Although the above description has been made with reference to equipment in the nature of telecommunications switching equipment, those skilled in the art will appreciate that other types of equipment may be used in conjunction with embodiments of the invention. Similarly, it will be appreciated by those skilled in the art that other types of signal carrying cable, such as hydraulic or pneumatic cable, may be implemented.

It will be understood by those skilled in the art that this description is made with reference to the illustrative embodiments and that it is possible to make other embodiments employing the principles of the invention and which fall within the spirit and scope thereof.

What is claimed is:

1. A bend radius control apparatus for a signal carrying cable, the bend radius control apparatus comprising:
a generally planar member;
a member with a convex curved surface presenting a predetermined radius of curvature, said curved surface being attached adjacent said generally planar member with the curved surface oriented generally perpendicular to the plane of the generally planar member;
wherein the signal carrying cable contacts said curved surface to thereby cause redirection of the orientation of the signal carrying cable while maintaining the signal carrying cable at a bend radius which is no less than said predetermined radius of curvature;
a first cable retaining member depending from said generally planar member; and
a second cable retaining member for retaining said signal carrying cable, wherein the second cable retaining member depends from one of said curved surface and said first cable retaining member to thereby form a cable channel which is generally defined by said generally planar member, by said curved surface, and by said first and second cable retaining members, and into which said at least one signal carrying cable is locatable; and
wherein the first and second cable retaining members are oriented such that an opening is provided between said first and second cable retaining members, the curved surface and the generally planar member, through which said at least one signal carrying cable may be introduced and retained.
